(19) United States
(12) Patent Application Publication
(10) Pub. No.: US 2009/0201142 A1
(43) Pub. Date: Aug. 13, 2009

(54) Wireless Sensor System

(75) Inventors: Jun Zou, College Station, TX (US); Murat K. Yapici, College Station, TX (US); Lamyanba Yambem, College Station, TX (US)

Correspondence Address: Tod T. Tumey, P.O. BOX 22188, HOUSTON, TX, 77227-2188, US

(73) Assignee: The Texas A&M University System, College Station, TX (US)

(21) Appl. No.: 12/368,165

(22) Filed: Feb. 9, 2009

Related U.S. Application Data
(60) Provisional application No. 61/026,976, filed on Feb. 7, 2008.

(51) Int. Cl. G08B 26/00; H04Q 5/22

(52) U.S. Cl. 340/505; 340/10.42

(57) ABSTRACT

A wireless sensor system identifies a single event in a wireless link. In an embodiment, the wireless sensor system includes an interrogator comprising an oscillator, a power amplifier, an antenna, and a detection circuit. The wireless sensor system also includes a sensor tag. The interrogator and the sensor tag are adapted to inductively couple the antenna and the sensor tag. The detection circuit detects a signal across the antenna, and the single event changes the signal across the antenna. In addition, the detection circuit provides the identification of the single event by detecting the change in the signal across the antenna.

### CROSS-REFERENCE TO RELATED APPLICATIONS

This application is a non-provisional application that claims the benefit of U.S. Application Ser. No. 61/026,976 filed on Feb. 7, 2008, which is incorporated by reference herein in its entirety.

### STATEMENT REGARDING FEDERALLY SPONSORED RESEARCH OR DEVELOPMENT

This application was made with government support under TEES start-up find 32293-18918.

### BACKGROUND OF THE INVENTION

1. Field of the Invention

This invention relates to the field of sensors and more specifically to wireless sensors for monitoring and detecting events.

2. Background of the Invention

Smart sensors have been developed for household applications. The smart sensors have been developed to provide a more secure and amiable living environment. Smart sensors include temperature, humidity, and smoke detectors. Drawbacks to conventional smart sensors include inefficiencies in detecting and reporting occurrence of an event in locations that are not easily observed or where the occurrence is in a location not easily available. For instance, conventional smart sensors may not be sufficient for such applications as water leakage behind walls, wetting of diapers, and the spillage of food in a storage room.

Remote query sensor systems have been developed to overcome some of such drawbacks. For instance, such remote query sensor systems include radio frequency transmission, inductive coupling, surface acoustic waves, and modified radio frequency identification readers and tags. Drawbacks to such remote query sensor systems include the complex circuitry involved, which typically increases financial costs. Further drawbacks include that specific communication protocols may be needed to ensure reliable wireless data transmission and reception.

Consequently, there is a need for an improved event monitoring system. Additional needs include an improved wireless sensor system. Moreover, needs include a universal wireless sensor system that provides on/off states under different application scenarios.

### BRIEF SUMMARY OF SOME OF THE PREFERRED EMBODIMENTS

These and other needs in the art are addressed in one embodiment by a wireless sensor system that identifies a single event in a wireless link. The wireless sensor system includes an interrogator comprising an oscillator, a power amplifier, an antenna, and a detection circuit. The wireless sensor system also includes a sensor tag. The interrogator and the sensor tag are adapted to inductively couple the antenna and the sensor tag. The detection unit detects a signal across the antenna, and the single event changes the signal across the antenna. In addition, the detection circuit provides the identification of the single event by detecting the change in the signal across the antenna.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates a block diagram of a wireless sensor system having an interrogator, a sensor tag, and an inductive link;

FIG. 2 illustrates a top perspective view of a sensor tag;

FIG. 3 illustrates a cross sectional side view of a sensor tag;

FIG. 4 illustrates a schematic circuit diagram of a wireless sensor system having an interrogator, a sensor tag, and an inductive link;

FIG. 5 illustrates a wire spiral antenna;

FIG. 6 illustrates a printed circuit antenna;

FIG. 7 illustrates AC voltage waveform of the antenna coil at 7 cm separation when the diaper is dry;

FIG. 8 illustrates AC voltage waveform of the antenna coil at 7 cm separation when the diaper is wet; and

FIG. 9 illustrates voltage shift at the comparator input for different separation between the sensor tag and antenna.

### DETAILED DESCRIPTION OF THE PREFERRED EMBODIMENTS

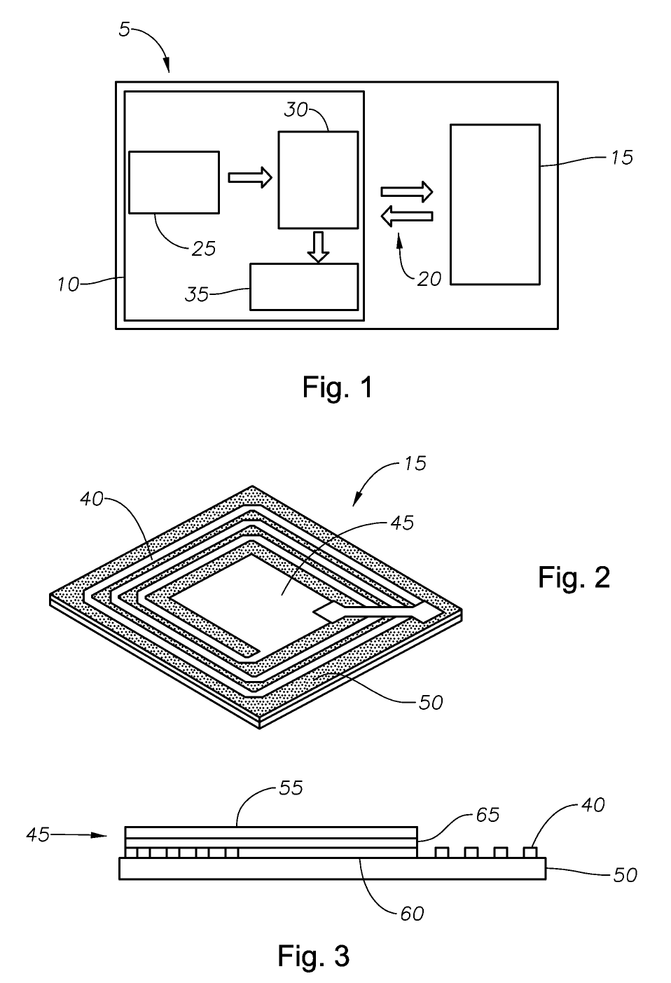

FIG. 1 illustrates a block diagram of wireless sensor system 5. Wireless sensor system 5 includes interrogator 10, sensor tag 15, and inductive link 20. Interrogator 10 and sensor tag 15 communicate with each other through wireless telemetry, which is accomplished by inductive link 20. In embodiments, interrogator 10 is not integral with sensor tag 15. In an embodiment, an environmental event that shifts the resonating frequency of sensor tag 15 modifies inductive link 20, which triggers an ON condition reflected at interrogator 10. Interrogator 10 reflects an OFF condition when modification of inductive link 20 includes changes in the signal of antenna 90 of interrogator 10. In an embodiment, such changes in the signal include changes in the current and/or voltage. For instance, in some embodiments, when sensor tag 15 is placed in the vicinity of interrogator 10, sensor tag 15 inductively couples with antenna 90 and draws current from antenna 90, which lowers the total current flowing in the circuit. Such current change is reflected as a voltage drop over antenna 90. In embodiments, any environmental change may reduce or terminate the inductive coupling, which may result in an increase in the signal passing through antenna 90. Such increase is used to indicate the occurrence of the environmental event. Without limitation, since the coupling is based on electromagnetic induction, wireless sensor system 5 provides wireless event monitoring and detection without having to physically connect the reading unit (interrogator 10) and sensing unit (sensor tag 15) in an integrated unit. Further, without limitation, the recognition of two states (ON or OFF) reduces the system complexity but maintains the functionality sufficient in applications where event detection is desired. Further, without limitation, by reducing the system complexity, wireless sensor system 5 provides an easy-to-use and cost-effective solution for monitoring and detecting environmental events. Environmental events include any environmental condition that may be monitored such as moisture, water leakage, temperature, humidity, smoke, gas detection, and the like. The event may be repeatable.

Interrogator 10 may include any circuitry suitable for providing interrogator functions and communicating with sensor tag 15 through inductive link 20. In an embodiment as illustrated in FIG. 1, interrogator 10 includes oscillator 25, power amplifier 30, and detection circuit 35. Oscillator 25 may include any electronic circuit suitable for producing an electronic signal for use in interrogator 10. In an embodiment, oscillator 25 is a crystal oscillator. Without limitation, the crystal oscillator stabilizes the frequency. Power amplifier 30 may be any device suitable for changing the amplitude of a signal. In an embodiment, power amplifier 30 is a Class E power amplifier. Detection circuit 35 includes any electrical circuitry suitable for providing an indicator of the event.

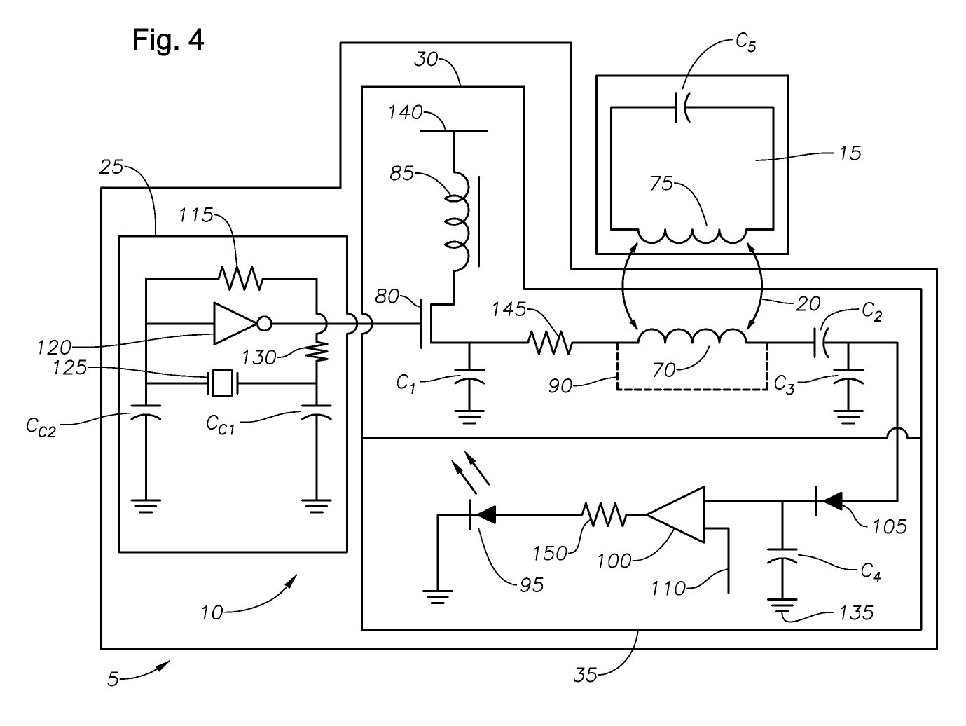

Sensor tag 15 may include any sensor tag suitable for detecting a desired environmental event. In some embodiments, sensor tag 15 is a passive sensing device. In an embodiment, sensor tag 15 is an L-C circuit. In an embodiment, a particular sensor tag 15 is selected for a desired environmental event. FIG. 2 illustrates a perspective top view of an embodiment of a sensor tag 15 in which sensor tag 15 is an L-C circuit and includes inductor coils 40, capacitor 45, and base 50. Inductor coils 40 are any electrical coils suitable for use in a sensor tag. In the embodiment as shown in FIG. 2, capacitor 45 is a parallel plate capacitor. It is to be understood that capacitor 45 is not limited to a parallel plate capacitor but in alternative embodiments may include any other type of capacitor. Sensor tag 15 is fabricated on base 50. Base 50 may include any base suitable for use in a sensor tag 15. In an embodiment as illustrated, base 50 is a printed circuit board. In alternative embodiments (not illustrated), sensor tag 15 is fabricated through photolithography. For instance, in some alternative embodiments, the power of microelectronics fabrication is used for the photolithography. Without limitation, photolithography reduces the cost of sensor tag 15 fabrication and may also allow fabrication on flexible (i.e., plastic, polymer, and the like) substrates (base 50) with small footprints, which allows their use in applications that require smaller components. In embodiments as illustrated, sensor tag 15 has rectangular inductor coils 40 forming the inductor, and parallel plates inside the rectangular coils forming capacitor 45. FIG. 3 illustrates a cross sectional side view of the embodiment of sensor tag 15 illustrated in FIG. 2. As shown in FIG. 3, capacitor 45 includes dielectric 65 disposed between top layer 55 and bottom layer 60. It is to be further understood that sensor tag 15 is not limited to such configuration but in alternative embodiments may include any other suitable configuration. In an embodiment, inductor coils 40 and capacitor 45 are designed to provide a resonant frequency that is the same as the frequency transmitted by antenna 90, as illustrated in FIG. 4. In some embodiments, inductor coils 40 and capacitor 45 provide the same frequency as the antenna 90 during non-occurrence of an event. Without limitation, such a design facilitates optimization of the inductive coupling (i.e., inductive link 20). In an embodiment, the frequency is about 12 MHz.

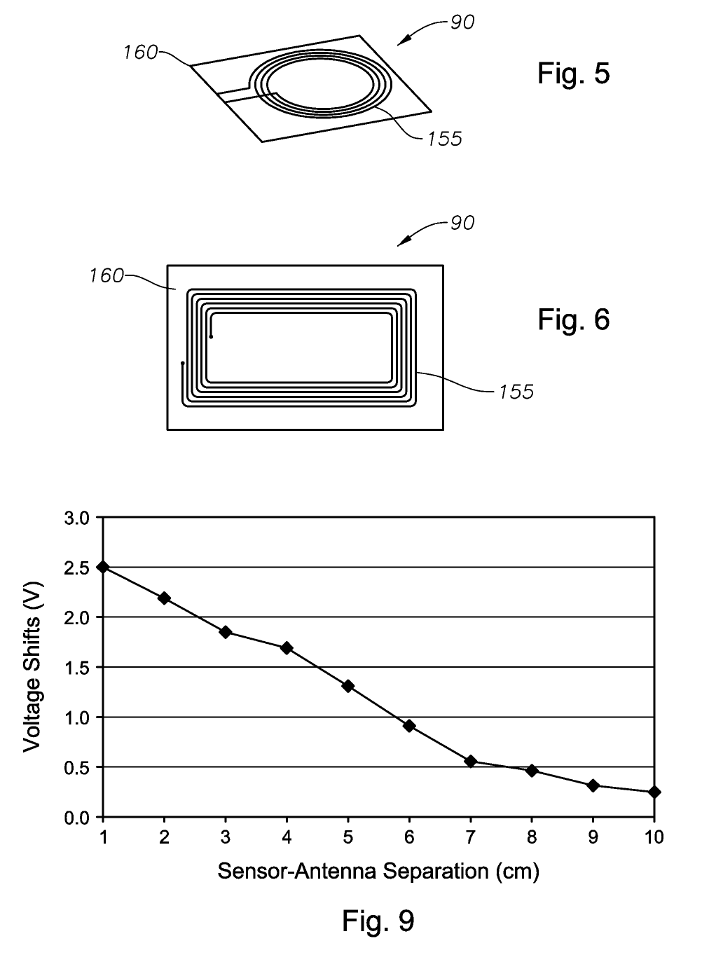

FIG. 4 illustrates a schematic circuit diagram of wireless sensor system 5. In the embodiment as shown, oscillator 25 is a crystal oscillator and includes inverter 120, crystal resonator 125, resistors 115 and 130, and capacitors C_{C1} and C_{C2}. It is to be understood that oscillator 25 is not limited to the embodiment shown in FIG. 4 but may also include any other configurations and circuitry suitable for user in interrogator 10. In the embodiment as illustrated in FIG. 4, power amplifier 30 includes field effect transistor 80; choke coil 85; supply voltage 140; capacitors C₁, C₂, and C₃; resistor 145; and antenna 90. Supply voltage 140 may include any voltage suitable for an amplifier. Antenna 90 may include any antenna configuration suitable for use in wireless sensor system 5. In an embodiment as illustrated in FIG. 5, antenna 90 includes electrical wire 155 wound into a spiral structure and disposed on antenna base 160. Antenna base 160 may be any base suitable for use with an antenna. In an embodiment, antenna base 160 is printed circuit board. Electrical wire 155 may include any electrical wire suitable for use in an antenna. In the embodiment as illustrated, electrical wire 155 is wound into a four-turn spiral structure. The four-turn spiral structure may include any suitable outer diameter and spacing for use in interrogator 10. Without limitation, in such an embodiment, the outer diameter and spacing between adjacent turns is selected to provide power amplifier 30 with sufficient inductance to achieve a target operation frequency. For instance, in an embodiment, the target operation frequency may be 12 MHz. FIG. 6 illustrates an alternative embodiment of antenna 90 in which electrical wire 155 is disposed on antenna base 160 in a printed circuit pattern. In such an alternative embodiment, electrical wire 155 may have any suitable number of turns, spacing between turns, and outer dimensions for use in interrogator 10. In an embodiment as illustrated in FIG. 6, electrical wire 155 has six turns. Antenna 90 is not limited to the configurations of FIGS. 5 and 6 but may also include any other suitable configurations. In an embodiment as illustrated in FIG. 4, supply voltage 140 provides voltage V_{dd}. Detection circuit 35 includes rectifier 105, capacitor C₄, comparator 100, resistor 150, and indicator 95. Rectifier 105 includes any electrical device suitable for converting alternating current to direct current. In an embodiment, rectifier 105 is a diode. Indicator 95 includes any device suitable for providing a notification that the ON condition is achieved. For instance, indicator 95 may be a light source or a sound producing source (i.e., that beeps or vibrates upon the presence of an ON condition). The light source may be any suitable light source for indicating the ON condition. In an embodiment, the light source is a light emitting diode (LED). It is also to be understood that detection circuit 35 is not limited to the embodiment illustrated in FIG. 4 but may also include other circuitry and configurations suitable for use as a detection circuit in wireless sensor system 5. In the embodiment shown in FIG. 4, sensor tag 15 also includes capacitor C_{S} and sensor tag inductance 75. Wireless sensor system 5 comprises the appropriate grounds 135.

In the embodiment as shown in FIG. 4, oscillator 25 generates a square wave that is fed into field effect transistor 80 of power amplifier 30. Field effect transistor 80 acts as a switch, charging and discharging capacitor C₁ according to the gating signal, generating a sinusoidal RF current in its output branch. Amplifier inductance (Lₐ) 70 is provided by antenna 90, which transmits/receives the RF to/from sensor tag 15 by inductively coupling with sensor tag inductance (L_{S}) 75. The impedance introduced by sensor tag 15 in the circuit (i.e., through inductive link 20) may change with the resonant frequency of sensor tag 15, which may vary according to the condition that it senses. The change of impedance may alter the current flowing in power amplifier 30 circuit, which detects the condition of sensor tag 15 by observing the voltage over amplifier inductance (Lₐ) 70 and capacitors C₁ and C₂. Rectifier 105 converts the AC signal from power amplifier 30 to a direct current (DC) voltage, which is fed into comparator 100 and compared with the reference voltage (V_{ref}) 110. In an embodiment, the reference voltage 110 (or reference signal) is set about the same as the voltage (or signal) from antenna 90 during non-occurrence of an event. In such an embodiment, a difference between the reference voltage 110 and rectifier 105 voltage (the signal) provides an output from comparator 100 that indicates the ON condition to indicator 95. In some embodiments, reference voltage 110 is set just below the voltage from rectifier 105 (i.e., from antenna 90) at which the environmental event occurs. In an embodiment in which the input voltage (i.e., voltage from rectifier 105) rises above reference voltage 110, the output voltage from comparator 100 then goes high, which output is reflected by indicator 95 indicating an ON condition. For instance, in an embodiment in which indicator 95 is a LED, the LED illuminates to indicate the ON condition. In an alternative embodiment, the reference voltage (i.e., reference signal) is set above the signal from antenna 90 at which the environmental event occurs.

In an embodiment, inductive link 20 between sensor tag 15 and antenna 90 may be considered in the form of a mutual inductance (M). For instance, a sinusoidal current i₁ of frequency ω flows in the antenna coil and induces a current i₂ on the sensor circuit. If L₁ and L₂ are the inductance of antenna 90 and the sensor coil, respectively, and C₂ is the sensor capacitance, the relations between i₁ and i₂ may be written as the following Equation (1).

jωMi₁=jωL₂i₂+R₂i₂+i₂/jωC₂

In Equation (1), as conventionally used in circuit theory, j refers to the imaginary number equivalent to the square root of −1. R₂ refers to the sensor tag 15 resistance.

With U₀ as the source voltage and R₁ and C₁ representing the resistance and capacitance of interrogator 10 circuit, the effect of inductive link 20 on the interrogator 10 side is determined by the following Equation (2).

U₀=R₁i₁+jωL₁i₁+(R₁/jωC₁)−jωMi₂

The total impedance (Z_{S}) of sensor tag 15 as seen through inductive link 20 is provided by the following Equation (3).

Z_{S}=ω²M²/(jωL₂+R₂+(jωC₂)⁻¹)

The total impedance of interrogator 10 circuit is given by Z_{R}, and i₁ is written as shown in the following Equation (4).

i₁=U₀/(Z_{R}+Z_{S})

When sensor tag 15 is disabled by an event such as for example water leakage or wetting of a diaper, the sensor impedance Z_{S} vanishes, which results in an increase in i₁. Such change in i₁ is reflected as a voltage change (ΔV) across the capacitor C₂ as shown by the following Equation (5). Z_{C} is the impedance of the capacitor at that frequency.

ΔV=U₀Z_{C}/(Z_{R}+Z_{S})

The above equations and relationships were a result of findings by the inventors.

To further illustrate various illustrative embodiments of the present invention, the following examples are provided.

### EXAMPLES

A set of experiments were conducted. The schematic circuit diagram of wireless sensor system 5 illustrated in FIG. 4 was used. Two different sets of coils were developed for antenna 90 to determine the effect of the coils' size and inductance on the operating range of sensor tag 15. The first set of coils was made on a printed circuit board with six turns and a spacing of 0.5 mm between adjacent turns. The outer dimensions were 60 mm by 30 mm. The second set of coils was made of an electrical wire wound into a 4-turn spiral structure with an outer diameter of 12 cm and a spacing of 2 cm between adjacent turns. The printed circuit board and the wire antenna had inductances of 2.4 μH and 3.1 μH, respectively. The circuit was powered by a single 9 volt DC source. The class E amplifier produced an RF voltage of 12 MHz on the antenna.

A diaper was soaked with a solution of sodium chloride in distilled water (10 grams/liter). The diaper was used to simulate a condition of a wet diaper. The sensor tag was placed in contact with the diaper at a certain distance from the antenna. According to Equation (5), the wetting of the diaper with ion-containing sodium chloride solution should result in impedance change as well as voltage shift at the interrogator side.

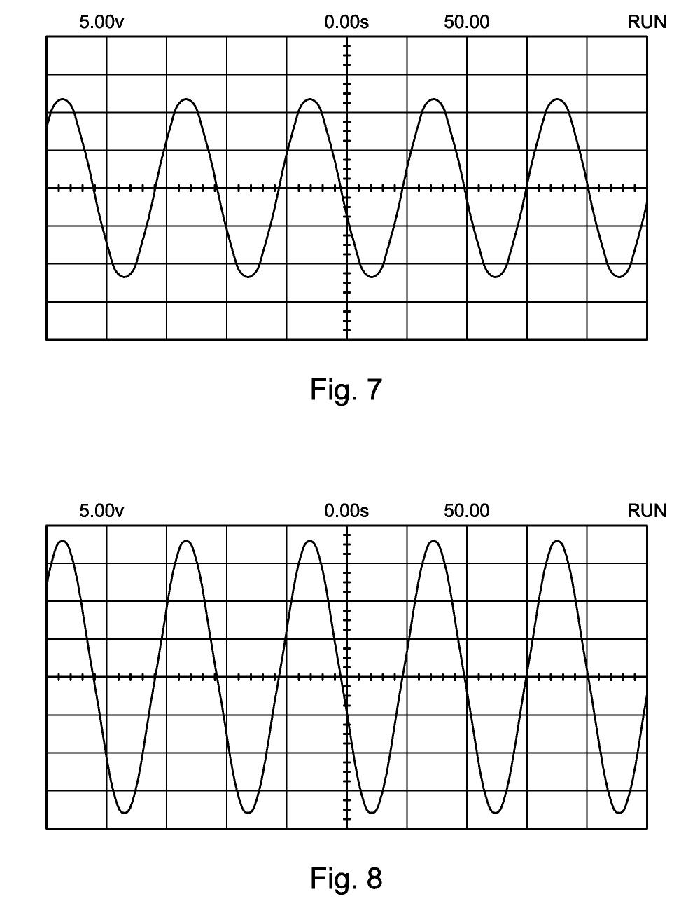

The effect of separation on the voltage shift between the DRY and WET conditions were investigated for both antennas to determine the effective operating range of the sensor. It was found that the printed circuit board antenna had a limited range of 3 cm with a voltage shift of 500 mV at this separation. For the wire antenna, since it had a larger diameter and the magnetic field was more spread out than the printed antenna, it provided an extended range of 10 cm at which stable voltages shift and which were easily distinguished as DRY/WET conditions by the comparator as shown in FIG. 9. The voltage shift between the two conditions for the wire antenna at a separation for 7 cm was shown for both DC inputs to the comparator and the RF voltage at the antenna in FIGS. 7 and 8.

Without limitation, wireless sensor system 5 eliminates the need for complex circuitry and is capable of sensing various events applicable to a number of practical situations. Further, without limitation, wireless sensor system 5 provides the advantage of reducing the cost of the sensor system because of the simplicity of the circuit and the absence of power in the sensor. Moreover, by developing sensor tags with different functionalities, wireless sensor system 5 may be readily adapted to different applications for environmental event monitoring.

Although the present invention and its advantages have been described in detail, it should be understood that various changes, substitutions and alterations may be made herein without departing from the spirit and scope of the invention as defined by the appended claims.

What is claimed is:

1. A wireless sensor system for identification of a single event in a wireless link, comprising:
an interrogator comprising an oscillator, a power amplifier, an antenna, and a detection circuit;
a sensor tag; and
wherein the interrogator and the sensor tag are adapted to inductively couple the antenna and the sensor tag, and wherein the detection circuit detects a signal across the antenna, and further wherein the single event changes the signal across the antenna, and wherein the detection circuit provides the identification of the single event by detecting the change in the signal across the antenna.

2. The wireless sensor system of claim 1, wherein the oscillator comprises a crystal oscillator.

3. The wireless sensor system of claim 1, wherein the interrogator recognizes conditions consisting of on and off, and wherein the on condition comprises identification of the single event and the off condition comprises non-occurrence of the single event.

4. The wireless sensor system of claim 1, wherein the sensor tag comprises inductor coils, a capacitor, and a base.

5. The wireless sensor system of claim 4, wherein the capacitor is a parallel plate capacitor.

6. The wireless sensor system of claim 4, wherein the inductor coils and the capacitor provide a resonant frequency that is about the same frequency as a frequency provided by the antenna.

7. The wireless sensor system of claim 1, wherein the antenna comprises electrical wire wound into a spiral structure.

8. The wireless sensor system of claim 7, wherein the spiral structure comprises a six-turn spiral structure.

9. The wireless sensor system of claim 1, wherein the signal comprises current.

10. The wireless sensor system of claim 1, wherein the signal comprises voltage.

11. The wireless sensor system of claim 1, wherein the detection circuit comprises a rectifier, a comparator, and an indicator.

12. The wireless sensor system of claim 11, wherein the rectifier converts alternating current from the interrogator to direct current, and wherein the alternating current comprises the signal.

13. The wireless sensor system of claim 11, wherein the comparator compares the signal to a reference signal to provide an output.

14. The wireless sensor system of claim 13, wherein when the reference signal is different than the signal, the indicator reflects an on condition, and wherein the on condition reflects identification of occurrence of the event.

15. The wireless sensor system of claim 13, wherein when the reference signal is the same as the signal, the indicator reflects an off condition, and wherein the off condition reflects a non-occurrence of the event.

16. The wireless sensor system of claim 1, wherein the interrogator comprises an indicator.

17. The wireless sensor system of claim 16, wherein the indicator comprises a light emitting diode.

18. The wireless sensor system of claim 1, further comprising sensor tags having different functionalities.

19. The wireless sensor system of claim 1, wherein the event is repeatable.

20. The wireless sensor system of claim 1, wherein the interrogator is not integral with the sensor tag.
